(19) United States
(12) Patent Application Publication
(10) Pub. No.: US 2018/0348500 A1
(43) Pub. Date: Dec. 6, 2018

(54) SCANNING MICROSCOPE WITH REAL TIME RESPONSE

(71) Applicant: SCOPIO LABS LTD., Tel Aviv (IL)

(72) Inventors: Erez NAAMAN, III, Tel Aviv (IL); Michael Shimon ILUZ, Tel Aviv (IL); Itai HAYUT, Tel Aviv (IL)

(21) Appl. No.: 15/774,881

(22) PCT Filed: Nov. 10, 2016
(86) PCT No.: PCT/IB2016/001714

§ 371 Date: May 9, 2018

Related U.S. Application Data
(60) Provisional application No. 62/253,734, filed on Nov. 11, 2015.

(51) Int. Cl. G02B 21/36; H04N 5/232

(52) U.S. Cl. CPC G02B 21/367; G02B 21/06; H04N 5/23232

(57) ABSTRACT

Microscopes and methods for processing images of a sample are disclosed. In one implementation, a microscope includes an illumination assembly configured to illuminate the sample under two or more different illumination conditions. The microscope further includes at least one image capture device configured to capture image information associated with the sample and at least one controller. The at least one controller is programmed to receive, from the at least one image capture device, a plurality of images associated with the sample. At least a first portion of the plurality of images is associated with a first region of the sample, and a second portion of the plurality of images is associated with a second region of the sample. The at least one controller is further programmed to initiate a first computation process to generate a high resolution image of the first region by combining image information selected from the first portion of the plurality of images; receive, after initiating the first computation process and before completing the first computation process, a request associated with prioritizing a second computation process for generating a high resolution image of the second region; and initiate, after receiving the request, the second computation process to generate the high resolution image of the second region by combining image information selected from the second portion of the plurality of images.

### CROSS REFERENCE TO RELATED APPLICATION

This application claims the benefit of priority of U.S. Provisional Patent Application No. 62/253,734, filed on Nov. 11, 2015. The foregoing application is incorporated herein by reference in its entirety.

### BACKGROUND

### Technical Field

The present disclosure relates generally to computational microscopy and, more specifically, to microscopes and methods that improve response times for processing images of a sample and collecting images of a sample.

### Background Information

As technology continues to advance in the field of computational imaging processing, a new generation of microscopes is emerging. Today's commercial microscopes rely on expensive and delicate optical lenses and typically need additional hardware to share the acquired images. Moreover, for scanning optical microscopy, additional expensive equipment such as accurate mechanics and scientific cameras are required. The new generation of microscopes, known as computational microscopy, overcomes the limitations of the commercial microscopes using advanced image-processing algorithms (usually with hardware modifications). A computational scanning microscope can produce high-resolution digital images of a sample, including medical samples. However, a scan of a sample can take significant time, even hours, to complete. Previous work was focused on reducing the time until the image is accessible, by reducing the time it takes to acquire the images and by reducing the runtime of the computation process. The disclosed devices and methods are directed at providing a new type of computational microscope; one that may decrease the time needed to produce high-resolution images and may improve user experience. The disclosed devices and methods may accomplish these goals by prioritizing the acquisition and computation process, e.g., according to the needs and requests of the user during the process.

### SUMMARY

The present disclosure provides microscopes and methods for computational microscopy. One disclosed embodiment is directed to a microscope for processing images of a sample. The microscope may include an illumination assembly configured to illuminate the sample under two or more different illumination conditions. The microscope may further include at least one image capture device configured to capture image information associated with to the sample. The microscope may further include at least one controller programmed to receive, from the at least one image capture device, a plurality of images associated with the sample. At least a first portion of the plurality of images may be associated with a first region of the sample, and a second portion of the plurality of images may be associated with a second region of the sample. The controller may be programmed to initiate a first computation process to generate a high resolution image of the first region by combining image information selected from the first portion of the plurality of images. The controller may be further programmed to receive, after initiating the first computation process and before completing the first computation process, a request associated with prioritizing a second computation process for generating a high resolution image of the second region. The controller may be further programmed to initiate, after receiving the request, the second computation process to generate the high resolution image of the second region by combining image information selected from the second portion of the plurality of images.

Consistent with a disclosed embodiment, a method for processing images of a sample is provided. The method may include receiving, from at least one image capture device, a plurality of images associated with the sample. At least a first portion of the plurality of images may be associated with a first region of the sample, and a second portion of the plurality of images is associated with a second region of the sample. The method may further include initiating a first computation process to generate a high resolution image of the first region by combining image information selected from the first portion of the plurality of images. The method may further include receiving, after initiating the first computation process and before completing the first computation process, a request associated with prioritizing a second computation process for generating a high resolution image of the second region. The method may further include initiating, after receiving the request, the second computation process to generate the high resolution image of the second region by combining image information selected from the second portion of the plurality of images.

Consistent with another disclosed embodiment, a microscope for processing images of a sample is provided. The microscope may include an illumination assembly configured to illuminate the sample under two or more different illumination conditions. The microscope may further include at least one image capture device configured to capture image information associated with the sample. The microscope may further include at least one controller programmed to initiate a first image capture process to cause the at least one image capture device to capture a first plurality of images of a first region associated with the sample. The controller may be further programmed to receive, while performing the first image capture process, a request associated with initiating a second image capture process to capture images of a second region associated with the sample. The controller may be further programmed to initiate the second image capture process to cause the at least one image capture device to capture a second plurality of images of the second region. The controller may be further programmed to process the second plurality of images to generate a high resolution image of the second region. The high resolution image of the second region may be generated by combining image information selected from the second plurality of images.

Consistent with another disclosed embodiment, a method is provided for processing images of a sample. The method may include initiating a first image capture process to cause at least one image capture device to capture a first plurality of images of a first region associated with the sample. The method may further include receiving, while performing the first image capture process, a request associated with initiating a second image capture process to capture images of a second region associated with the sample. The method may further include initiating the second image capture process to cause the at least one image capture device to capture a second plurality of images of the second region. The method may further include processing the second plurality of images to generate a high resolution image of the second region. The high resolution image of the second region may be generated by combining image information selected from the second plurality of images.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation of an exemplary microscope for processing images of a sample, consistent with the disclosed embodiments;

FIG. 2A is an exemplary partial side view of the microscope of FIG. 1, consistent with the disclosed embodiments;

FIG. 2B is an exemplary transparent top view of the microscope arm 122 of FIG. 1 housing two scanning motors. While stage 116 is visible in this transparent view through arm 122, the image capture device 102 and hardware connecting the motors to the image capture device, are not shown;

FIG. 3 is an exemplary transparent top view of the microscope arm of FIG. 1 housing four scanning motors, consistent with the disclosed embodiments;

FIG. 4A is a schematic illustration of an exemplary sample shown on a display with a second region of interest within a first region of interest, consistent with the disclosed embodiments;

FIG. 4B is a schematic illustration of an exemplary sample shown on a display with a second region of interest separate from a first region of interest, consistent with the disclosed embodiments;

FIG. 4C is a schematic illustration of an exemplary image shown on a display with a region surrounding a region of interest, consistent with the disclosed embodiments;

FIG. 5 is an illustration of an exemplary process for constructing an image of a sample using images acquired under a plurality of illumination conditions, consistent with disclosed embodiments;

FIG. 6 is a schematic illustration of an exemplary display showing a high resolution image of a region of interest, consistent with the disclosed embodiments;

FIG. 7 is a flowchart showing an exemplary process for prioritizing a computation process of images associated with a particular region of interest, consistent with the disclosed embodiments; and

FIG. 8 is a flowchart showing an exemplary process for prioritizing the image capture process of images associated with a particular region of interest, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

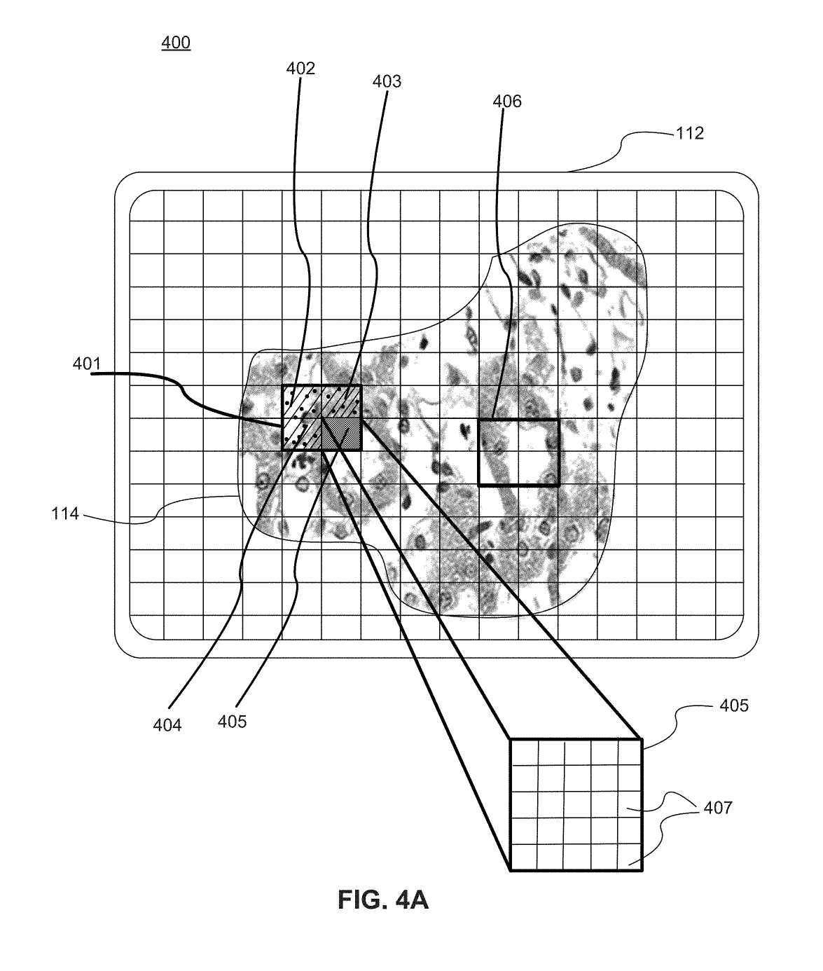

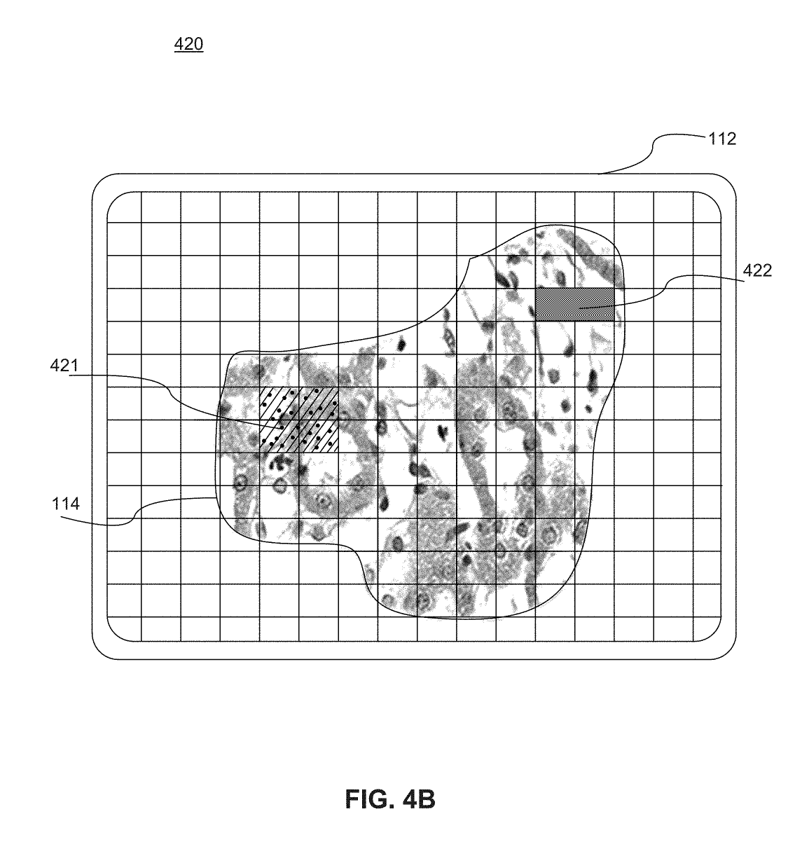

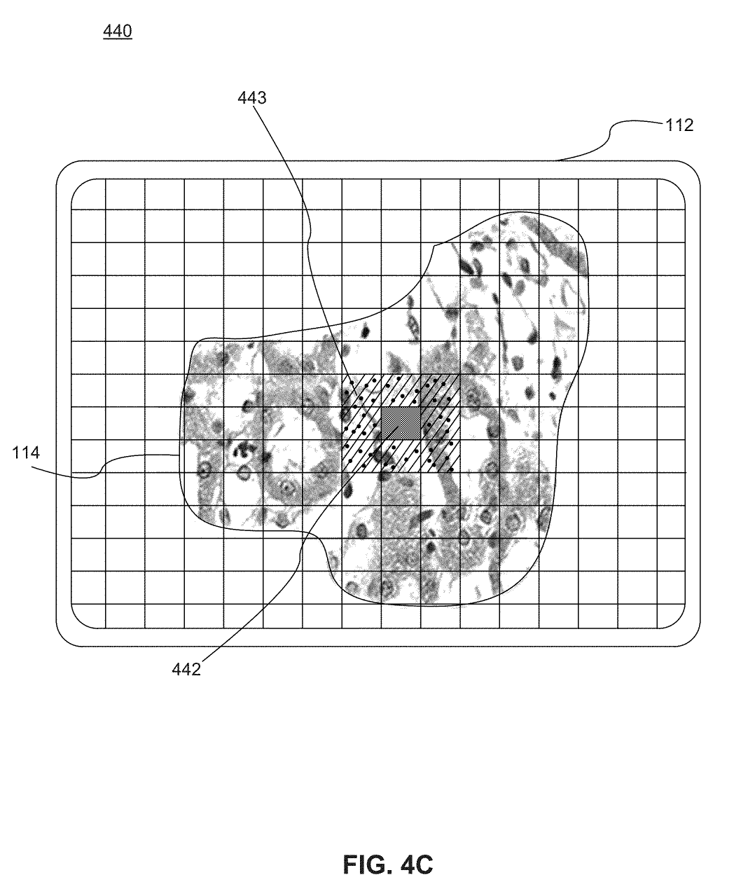

Disclosed embodiments provide microscopes and methods that use one or more cameras to provide high-resolution images of a sample. For example, the sample may include cells, tissue, plant material, materials surfaces, powders, fibers, microorganisms, etc. In some embodiments, the sample may be included on or in a supporting structure. For example, in some embodiments, the supporting structure may include a slide, such as a slide made from glass or other light transmissive material, or a glass plate. For purposes of this disclosure, references to the sample may refer to the subject matter to be imaged either together with or separate from any supporting structure present on which the subject matter to be imaged is placed (e.g., a slide). Further, in some embodiments, the supporting structure including the sample and/or the sample itself may be located on a stage of the microscope. In other embodiments, the supporting structure including the sample may be secured to the microscope via an attaching member, a holding arm, a clamp, a clip, an adjustable frame, a locking mechanism, a spring or any combination thereof. In various embodiments, the microscope may use images of the sample captured under a plurality of illumination conditions. In one aspect of the disclosure, the microscope may capture multiple images of the sample under each illumination condition, aggregate image data from these images, and construct a high-resolution image from the image data. This aspect of the disclosure is described in detail with reference to FIGS. 4-6. In one example, the microscope may aggregate the image data in the Fourier plane and then use inverse Fourier transform to reconstruct the high-resolution image.

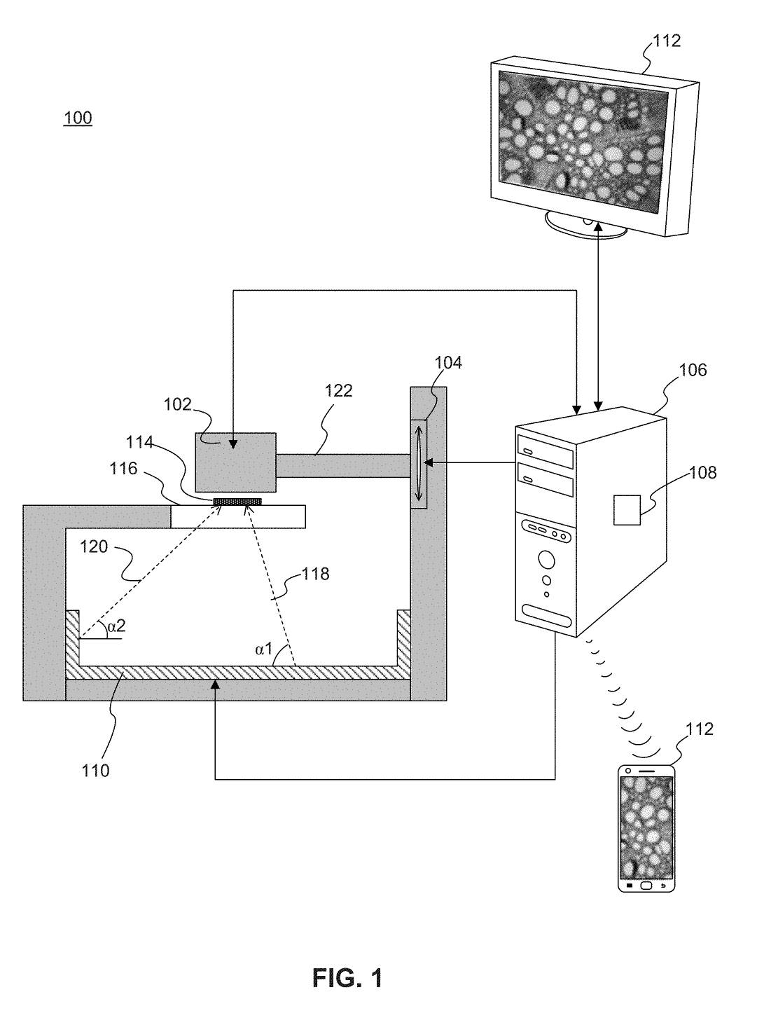

FIG. 1 is a diagrammatic representation of a microscope 100 consistent with the exemplary disclosed embodiments. The term “microscope” refers to any device or instrument for magnifying an object which is smaller than easily observable by the naked eye, i.e., creating an image of an object for a user where the image is larger than the object. One type of microscope may be an “optical microscope” that uses light in combination with an optical system for magnifying an object. An optical microscope may be a simple microscope having one or more magnifying lens. Another type of microscope may be a “computational microscope” that includes an image sensor and image-processing algorithms to enhance or magnify the object's size or other properties. The computational microscope may be a dedicated device or created by incorporating software and/or hardware with an existing optical microscope to produce high-resolution digital images. As shown in FIG. 1, microscope 100 includes an image capture device 102, a focus actuator 104, a computing device, i.e., a controller 106 connected to memory 108, an illumination assembly 110, and a user interface 112. An example usage of microscope 100 may be capturing images of a sample 114, mounted on a stage 116, located within the field-of-view (FOV) of image capture device 102, processing the captured images, and presenting on user interface 112 a magnified image of sample 114. In this specification, the term “external device” includes any device including at least one controller, for example, a computer, a smartphone, a tablet, or a smart watch. In another embodiment, microscope 100 including controller 106 can be housed inside one microscope housing.

Image capture device 102 may be used to capture images of sample 114. In this specification, the term “image capture device” includes a device that records the optical signals entering a lens as an image or a sequence of images. The optical signals may be in the near-infrared, infrared, visible, and ultraviolet spectrums. Examples of an image capture device include a CCD camera, a CMOS camera, a photo sensor array, a video camera, a mobile phone equipped with a camera, etc. Some embodiments may include only a single image capture device 102, while other embodiments may include two, three, or even four or more image capture devices 102. In some embodiments, image capture device 102 may be configured to capture images in a defined field-of-view (FOV). Also, when microscope 100 includes several image capture devices 102, image capture devices 102 may have overlap areas in their respective FOVs. Image capture device 102 may have one or more image sensors (not shown in FIG. 1) for capturing image data of sample 114. In other embodiments, image capture device 102 may be configured to capture images at an image resolution higher than 10 Megapixels, higher than 12 Megapixels, higher than 15 Megapixels, or higher than 20 Megapixels. In addition, image capture device 102 may also be configured to have a pixel size smaller than 5 micrometers, smaller than 3 micrometers, or smaller than 1.6 micrometer.

In some embodiments, microscope 100 includes focus actuator 104. The term “focus actuator” refers to any device capable of converting input signals into physical motion for adjusting the relative distance between sample 114 and image capture device 102. Various focus actuators may be used, including, for example, linear motors, electrostrictive actuators, electrostatic motors, capacitive motors, voice coil actuators, magnetostrictive actuators, etc. In some embodiments, focus actuator 104 may include an analog position feedback sensor and/or a digital position feedback element. Focus actuator 104 is configured to receive instructions from controller 106 in order to make light beams converge to form a clear and sharply defined image of sample 114. In the example illustrated in FIG. 1, focus actuator 104 may be configured to adjust the distance by moving image capture device 102. However, in other embodiments, focus actuator 104 may be configured to adjust the distance by moving stage 116, or by moving both image capture device 102 and stage 116.

Microscope 100 may also include controller 106 for controlling the operation of microscope 100 according to the disclosed embodiments. Controller 106 may comprise various types of devices for performing logic operations on one or more inputs of image data and other data according to stored or accessible software instructions providing desired functionality. For example, controller 106 may include a central processing unit (CPU), support circuits, digital signal processors, integrated circuits, cache memory, or any other types of devices for image processing and analysis such as graphical processing units (GPUs). The CPU may comprise any number of microcontrollers or microprocessors or processors configured to process the imagery from the image sensors. For example, the CPU may include any type of single- or multi-core processor, mobile device microcontroller, etc. Various processors may be used, including, for example, processors available from manufacturers such as Intel®, AMD®, etc. and may include various architectures (e.g., x86 processor, ARM®, etc.). The support circuits may be any number of circuits generally well known in the art, including cache, power supply, clock and input-output circuits. In some embodiments, controller 106 may represent multiple controllers, each being in charge of one or more tasks. For example, such tasks may include control of the motors, control of illumination, performing calculations, prioritizing tasks, etc. The tasks may be performed locally or remotely, for example, a remote controller may control the prioritization of the tasks, perform the calculations and other tasks over a network. The remote controller maybe in the cloud or at a remote location. In one example, a local controller which is part of controller 106 may control the operation of the microscope and performs local calculations, and a remote part of controller 106 may control or perform image recognition tasks on the images, queue prioritization and other tasks.

In some embodiments, controller 106 may be associated with memory 108 used for storing software that, when executed by controller 106, controls the operation of microscope 100. In addition, memory 108 may also store electronic data associated with operation of microscope 100 such as, for example, captured or generated images of sample 114. In one instance, memory 108 may be integrated into the controller 106. In another instance, memory 108 may be separated from the controller 106. Specifically, memory 108 may refer to multiple structures or computer-readable storage mediums located at controller 106 or at a remote location, such as a cloud server. Memory 108 may comprise any number of random access memories, read only memories, flash memories, disk drives, optical storage, tape storage, removable storage and other types of storage. Memory 108 may store images and/or other data in various data structures, such as a folder, a data array, a computational queue, or a computational stack. The term folder may refer to any data type where the elements are stored for further processing. The term “queue” refers to any data type or collection where the elements are processed in order, i.e., a first-in-first-out data structure. The term “stack” refers to any data type or collection where most recently added elements are processed, i.e., a last-in-first-out data structure.

Microscope 100 may include illumination assembly 110. The term “illumination assembly” refers to any device or system capable of projecting light to illuminate sample 114. Illumination assembly 110 may include any number of light sources, such as light emitting diodes (LEDs), lasers and lamps, configured to emit light. In one embodiment, illumination assembly 110 may include only a single light source, which is able to illuminate in two or more illumination conditions, such as through different light patterns, angles, etc. Alternatively, illumination assembly 110 may include two, four, five, sixteen, or even more than a hundred light sources organized in an array or a matrix. In some embodiments, illumination assembly 110 may use one or more light sources located at a surface parallel to illuminate sample 114. In other embodiments, illumination assembly 110 may use one or more light sources located at a straight or curved surface perpendicular or at an angle to sample 114.

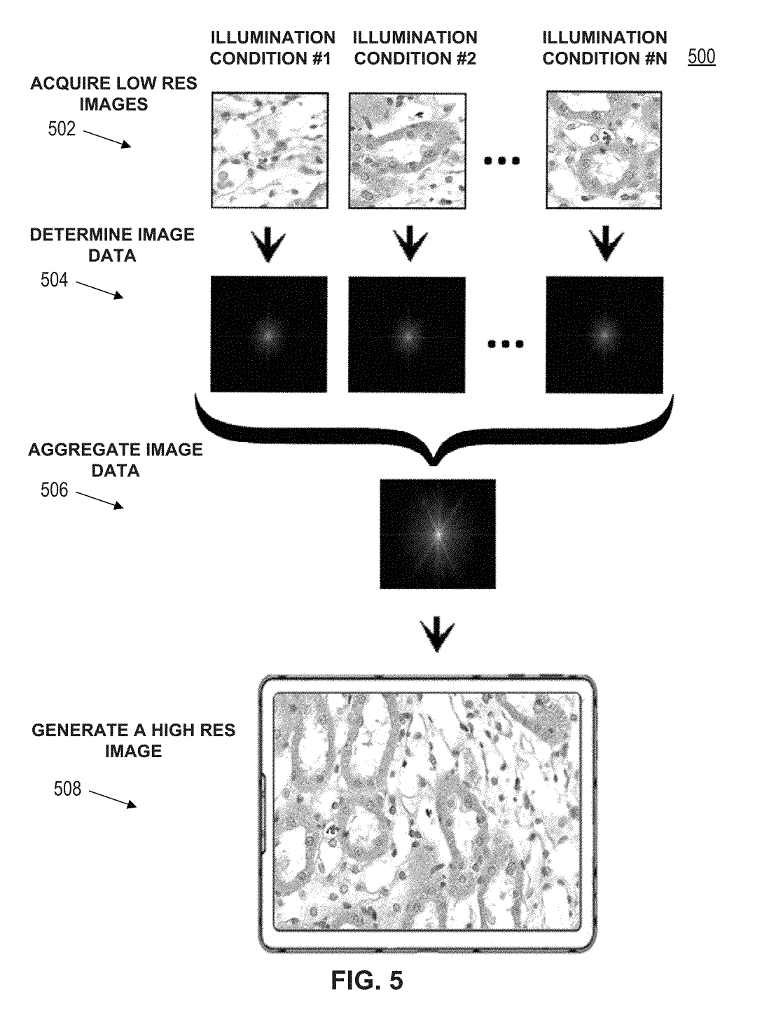

In addition, illumination assembly 110 may be configured to illuminate sample 114 in a series of different illumination conditions. In one example, illumination assembly 110 may include a plurality of light sources arranged in different illumination angles, such as a two-dimensional arrangement of light sources. In this case, the different illumination conditions may include different illumination angles. For example, FIG. 1 depicts a beam 118 projected from a first illumination angle α₁, and a beam 120 projected from a second illumination angle α₂. In another example, illumination assembly 110 may include a plurality of light sources configured to emit light in different wavelengths. In this case, the different illumination conditions may include different wavelengths. In yet another example, illumination assembly 110 may be configured to use a number of light sources. In this case, the different illumination conditions may include different illumination patterns generated by one or more light sources. Accordingly and consistent with the present disclosure, the different illumination conditions may be selected from a group including: different illumination angles, different durations, different intensities, different positions, different illumination patterns, different wavelengths, or any combination thereof. Controller 106 receives plurality of images associated with the sample and initiates a computation process to generate a high resolution image of the region by combining image information selected from a portion of the plurality of images, as described in further detail in FIG. 5.

Consistent with disclosed embodiments, microscope 100 may include, be connected with, or in communication with (e.g., over a network or wirelessly, e.g., via Bluetooth) user interface 112. The term “user interface” refers to any device suitable for presenting a magnified image of sample 114 or any device suitable for receiving inputs from one or more users of microscope 100. FIG. 1 illustrates two examples of user interface 112. The first example is a smartphone or a tablet wirelessly communicating with controller 106 over a Bluetooth, cellular connection or a Wi-Fi connection, directly or through a remote server. The second example is a PC display physically connected to controller 106. In some embodiments, user interface 112 may include user output devices, including, for example, a display, tactile device, speaker, etc. In other embodiments, user interface 112 may include user input devices, including, for example, a touchscreen, microphone, keyboard, pointer devices, cameras, knobs, buttons, etc. With such input devices, a user may be able to provide information inputs or commands to microscope 100 by typing instructions or information, providing voice commands, selecting menu options on a screen using buttons, pointers, or eye-tracking capabilities, or through any other suitable techniques for communicating information to microscope 100. User interface 112 may be connected (physically or wirelessly) with one or more processing devices, such as controller 106, to provide and receive information to or from a user and process that information. In some embodiments, such processing devices may execute instructions for responding to keyboard entries or menu selections, recognizing and interpreting touches and/or gestures made on a touchscreen, recognizing and tracking eye movements, receiving and interpreting voice commands, etc.

Microscope 100 may also include or be connected to stage. Stage 116 includes any rigid surface where sample 114 may be mounted for examination. Stage 116 may include a mechanical connector for retaining a slide containing sample 114 in a fixed position. The mechanical connector may use one or more of the following: a mount, an attaching member, a holding arm, a clamp, a clip, an adjustable frame, a locking mechanism, a spring or any combination thereof. In some embodiments, stage 116 may include a translucent portion or an opening for allowing light to illuminate sample 114. For example, light transmitted from illumination assembly 110 may pass through sample 114 and towards image capture device 102. In some embodiments, stage 116 and/or sample 114 may be moved using motors or manual controls in the XY plane to enable imaging of multiple areas of the sample.

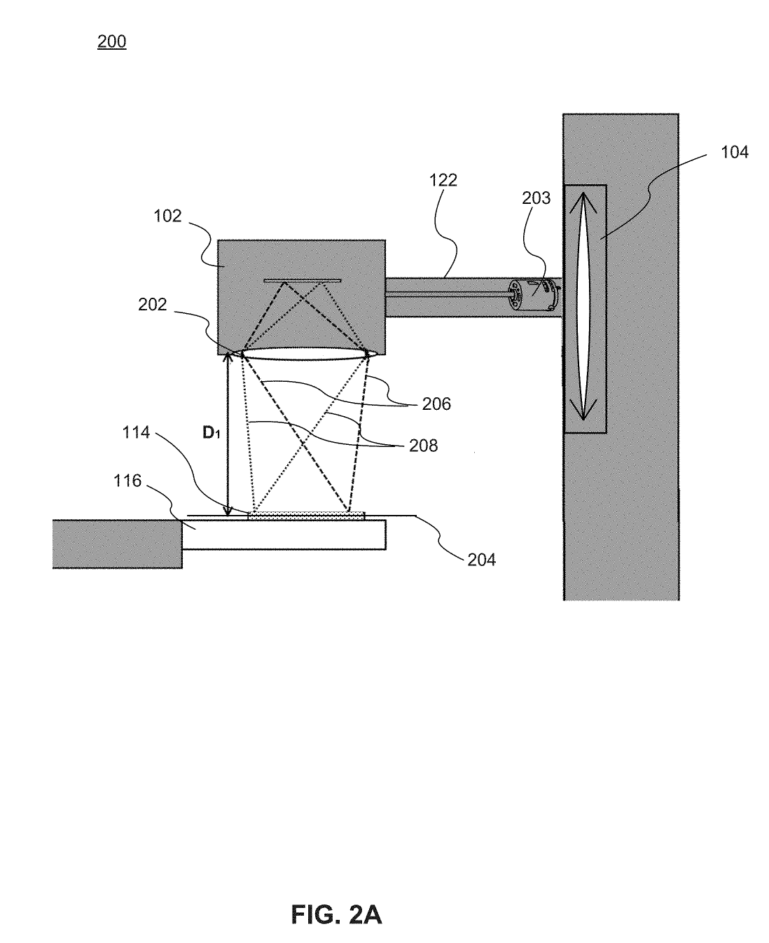

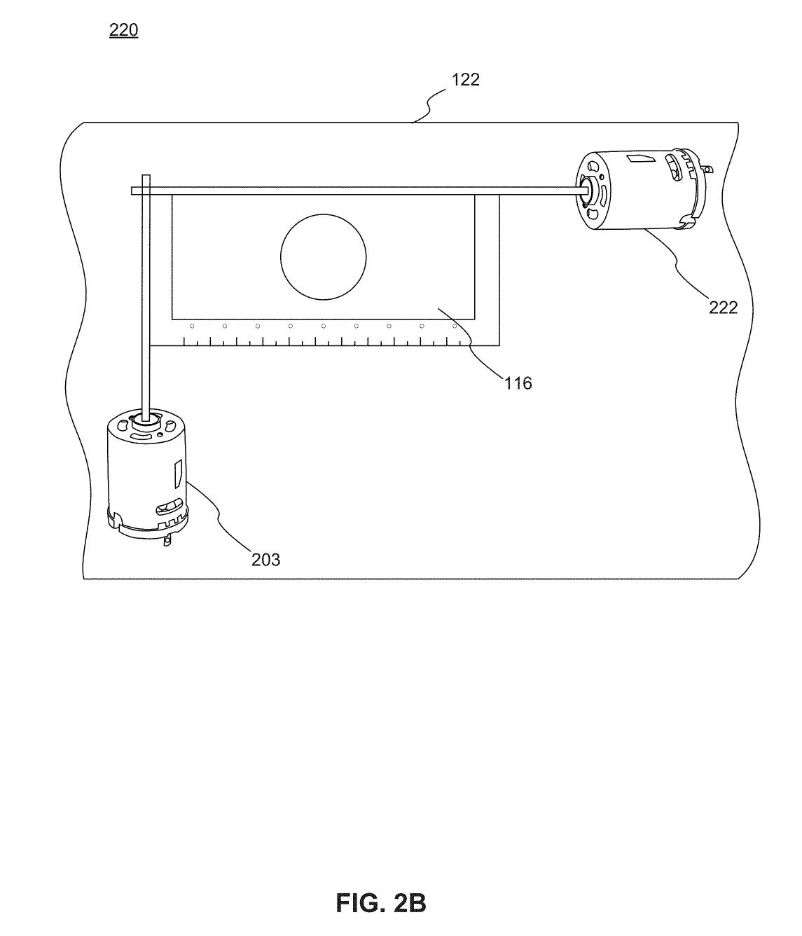

FIG. 2A is an exemplary side view 200 of the microscope of FIG. 1, consistent with the disclosed embodiments. As shown in FIGS. 2A and 2B, image capture device 102 may include an image sensor 200 and a lens 202. In microscopy, lens 202 may be referred to as an objective lens of microscope 100. Image capture device 102 may further include optical elements such as, but not limited to: lenses, a tube lens, a reduction lens, optical filters or apertures, active optical elements such as: spatial light modulators, LCD screens and others. In another embodiment, image capture device 102, may include an image sensor 200, without a lens. The term “image sensor” refers to a device capable of detecting and converting optical signals (e.g., light) into electrical signals. The electrical signals may be used to form an image or a video stream based on the detected signals.

Examples of image sensor 200 may include semiconductor charge-coupled devices (CCD), active pixel sensors in complementary metal-oxide-semiconductor (CMOS), or N-type metal-oxide-semiconductor (NMOS, Live MOS). The term “lens” may refer to a ground or molded piece of glass, plastic, or other transparent material with opposite surfaces either or both of which are curved, by means of which light rays are refracted so that they converge or diverge to form an image. The term “lens” also refers to an element containing one or more lenses as defined above, such as in a microscope objective. The term “lens” may also refer to any optical element configured to transfer light in a specific way for the purpose of imaging. In some embodiments, such a lens may include a diffractive or scattering optical element. The lens is positioned at least generally transversely of the optical axis of image sensor 200. Lens 202 may be used for concentrating light beams from sample 114 and directing them towards image sensor 200. In some embodiments, image capture device 102 may include a fixed lens or a zoom lens.

Microscope 100 or microscope 200 may also include motors 203 and 222 located, for example, within microscope arm 122. Motors 203 and 222 include any machine or device capable of repositioning image capture device 102 of microscope 100 or 200. Motor 203 may include a step motor, voice coil motor, brushless motor, squiggle motor, piezo motor, or other motors, or a combination of any motor. Motors 203 and 222 may move image capture device 102 to various regions over sample 114 on stage 116. Motors 203 and 222 can work in conjunction with focus actuator 104. While FIGS. 2A and 2B show an arrangement in which motors 203 and 222 are used to move image capture device 102 (e.g., in an X-Y plane), a similar arrangement (not shown) may be used to move stage 116 and/or sample 114 relative to image capture device 102. For example, motors similar to motors 203/222 (or any other suitable actuator or positioning controlling device) may be employed to translate stage 116 and/or sample 114 at least in the plane perpendicular to the optical axis of image capture device 102. Such actuators may include, for example, linear motors, rotational motors, combinations of coarse and fine motors and others. In some embodiments, in order to provide relative motion between image capture device 102 and stage 116 and/or sample 114, a position of image capture device 102 may be controlled. In other embodiments, this relative motion may be achieved through control of a position of stage 116 and/or sample 114. And, in still other embodiments, this relative motion may be achieved through a combination of control of the positions of both image capture device 102 and the positions of stage 116 and/or sample 114.

FIG. 2B is an exemplary transparent top view of microscope arm 122. As shown, microscope arm 122 houses two scanning motors, motor 222 and motor 203, consistent with the disclosed embodiments. Motor 203 may move image capture device 102 in the horizontal direction with respect to sample 114 on stage 116. Motor 222 may move image capture device 102 in the vertical direction with respect to sample 114 on stage 116. Memory 108 may store the position of image capture device 102. In some embodiments, controller 106 may be programmed to return image capture device 102 to a first region by way of motors 203 and 222. Further, motors 203 and 222 may work in conjunction with focus actuator 104.

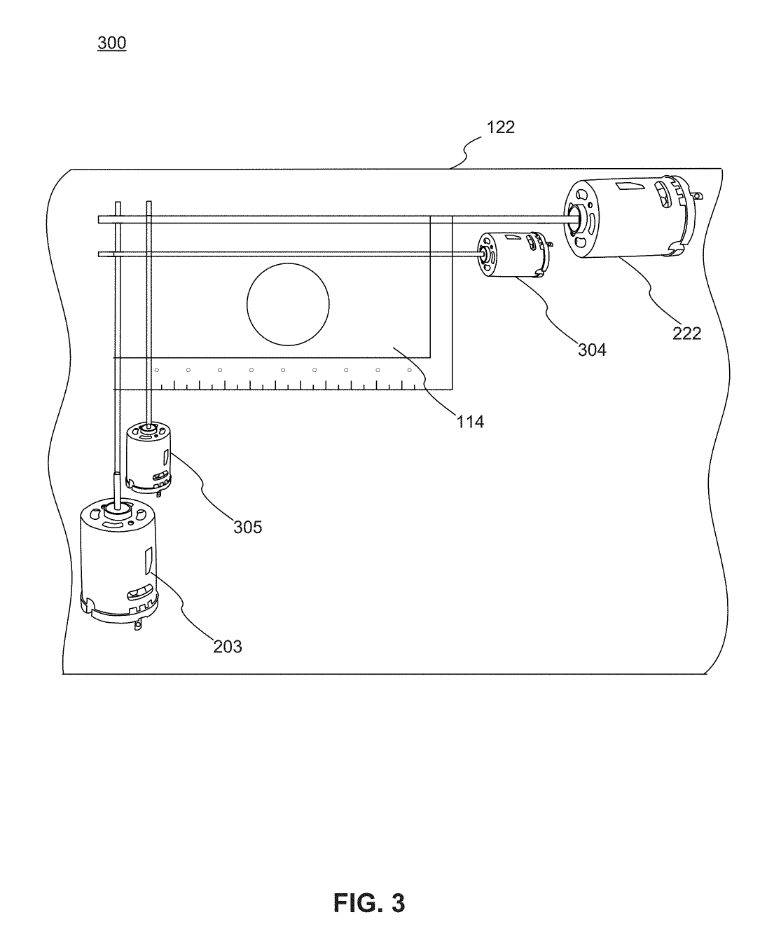

FIG. 3 is an exemplary transparent top view 300 of microscope arm 122 housing four scanning motors, consistent with the disclosed embodiments. Motors 203 and 305 can be used to achieve horizontal movement with respect to sample 114 on stage 116. Motors 222 and 304 can be used for vertical movement with respect to sample 114 on stage 116. Smaller motors 304 and 305 may be used for fine or slow movement of image capture device 102. Motors 222 and 203 may be used for coarse or fast movement of image capture device 102. In one embodiment, motors 222 and 203 may be used to move image capture device 102 from a first region towards a second region of sample 114 with large and fast movements. Once image capture device 102 is within close proximity to the second region, motors 304 and 305 are used for fine movement and place image capture device 102 in direct FOV of the second region. Memory 108 may store the position of the image capture device. Controller 106 may be programmed to return image capture device 102 to a first region by way of motors 203 and 222 initially, followed by motors 305 and 304. Motor 203, 222, 304 and 305 may work in conjunction with focus actuator 104.

FIG. 4A is a schematic illustration 400 of exemplary sample 114 shown on user interface 112. In contrast with other microscopic systems (e.g., computational microscopes) that may generate images based on serial and ordered image scans and/or serial and ordered computational processes, the presently disclosed systems may have the ability to significantly expedite access to selected image information through prioritization of image scans and/or prioritization of computation processes.

In one example of such a prioritization process, described relative to FIG. 4A, a user or an automated system may identify an area of interest (AOI) of which or within which higher resolution image information is desired. In the case of an automated system, such a system may include, for example, a specifically programmed computer configured to analyze captured image information, identify potential areas of interest within the captured images (for example, an area in an image corresponding to a monolayer of cells or other microscopic elements), select an area of interest from among the identified areas, and initiate a process for generating a higher resolution image of the selected areas of interest. In the case of a user, the user may view an image of sample 114 on a display of user interface 112. The user may use an available interface tool (e.g., a pointing device, stylus, touch screen, cursor, etc.) to identify an area of interest 401 for which a higher resolution image is desired. After receiving such a designation, microscope 100 may begin capturing a plurality of images to provide a basis for a computationally generated higher resolution image of area of interest 401.

For example, to capture images from which the higher resolution image may be generated, microscope 100 may position image capture device 102 and/or stage 116 or sample 116 such that a field of view (FOV) of image capture device 102 overlaps with area of interest 401. In some cases, the FOV of image capture device 102 may fully encompass area of interest 401. In those cases, microscope 100 may proceed by capturing multiple images, each being associated with a different illumination condition, of area of interest 401 falling within the FOV of image capture device 102. It is from these captured images that the controller may compute an image, having a resolution higher than any of the captured images.

In some cases, the FOV of image capture device 102 may not fully overlap with area of interest 401. In those cases, controller 106 may cause image capture device to move relative to stage 116 and/or sample 114 in order to capture images of the sample over the entire area of interest 401. For example, in some embodiments, controller 106 may partition the area of interest 401 into image capture regions, such as regions 402, 403, 404, or 405. In order to capture images needed to generate a high resolution image of area of interest 401, controller 106 may position image capture device 102 relative to sample 114 such that each image capture region falls within the FOV of image capture device 102. Then, for each image capture region, a plurality of images may be captured, and controller 106 (or other computational device) may generate the overall high resolution image of area of interest 401 based on the multiple images obtained for each of the image capture regions 402, 403, 404, and 405. The regions may partially overlap or have no overlap, and this may apply to any region in the examples described herein.

In some embodiments, computation of the high resolution image may proceed in a single process for an entire area of interest. That is, controller 106 may be capable of computationally assembling the high resolution image by processing the full areas of the images captured for the area of interest (where the FOV fully overlaps the area of interest) or by processing the full areas of the images captured for each image capture region.

In other embodiments, however, computation of the high resolution image may proceed on a more granular level. For example, the plurality of images associated with each unique position of the image capture device 102 relative to sample 114 may be processed by segmenting the image areas into computational blocks. Thus, for the examples described above, in the instance where the FOV of image capture device 102 fully overlaps area of interest 401, the images captured of area of interest 401 may be divided into blocks for processing. In order to generate the high resolution image of area of interest 401, controller 106 would serially (according to a predetermined order, or the order of acquisition or an algorithm to determine the order) process the image data from corresponding blocks of the plurality of images and generate a high resolution image portion for each block. In other words, controller 106 may collect all of the image data from the plurality of captured images falling within a first block and generate a portion of the high resolution image corresponding to a region of sample 114 falling within the first block. Processor 106 would repeat this process for the second block, third block, up to N-blocks until all of the computational blocks had been processed, and a complete high resolution image of area of interest 401 could be assembled.

In other cases, as noted above, the FOV of image capture device 102 may not overlap with an entire area of interest 401. In such cases, as described, area of interest 401 may be subdivided into image capture regions 402, 403, 404, and 405, for example. And, in order to generate a high resolution image of area of interest 401, a plurality of images captured for each image capture region may be processed to generate a portion of the high resolution image corresponding to each image capture region. The final high resolution image of area of interest 401 may be generated by combining the high resolution portions of the final image corresponding to each image capture area.

The plurality of images associated with each image capture region (each being associated with a different illumination condition) may be processed by analyzing and comparing the full areas of the capture images to one another. Alternatively, and similar to the process described above, however, the processing of the captured images may proceed in a stepwise fashion by processing portions of the captured images associated with respective computational blocks. With reference to FIG. 4A, for example, processing of an image capture region 405 (which may correspond to a FOV of image capture device 102 and a portion of area of interest 401) may proceed by processing the captured plurality of images associated with region 405 according to computational blocks 407. Each computational block 407 may be associated with a—portion of the plurality of images in region 405 and, therefore, may be associated with a—region of sample 114. Processor 106 may operate on a first computational block (for example, the block in the upper left corner of region 405) and compute a high resolution image segment associated with the first block based on the plurality of images captured at region 405. The high resolution image of area of interest may be obtained by processing each subsequent block 407 within region 405 (e.g., according to a predefined pattern or sequence or algorithm for choosing the order), generating a high resolution image segment for each block, combining the high resolution segments to obtain a high resolution image of region 405, and following similar processes for each of the other image capture regions (e.g., regions 402, 403, and 404) within area of interest 401. The high resolution image portions associated with each image capture region may be assembled together to provide the high resolution image of area of interest 401.

Generation of a high resolution image of area of interest 401 may require significant periods of time. For example, a certain amount of time may be associated with capturing of the plurality of images associated with area of interest 401 or image capture regions 402, etc. And, while computational speed of presently available controllers is significantly higher than those available even a few years ago (and the speed of controllers continues to improve), the computations associated with the generation of high resolution images of the area of interest may take considerable time.

This image capture time and computational time can slow and, therefore, hinder analysis of a sample by a user or automated system. For example, if while a particular area of interest is being imaged and processed, another area of interest 406 is identified, the user or system may have to wait until all image capture and processing relative to area 401 is complete before the system moves to area 406 for imaging and processing. The same may be true even within a particular area of interest. For example, if during imaging and/or processing of capture region 402 the user or system determines that the portion of sample falling within image capture region 405 is of more interest, the user or system may have to wait until all of the images of capture regions 402, 403, 404, and 405 have been captured, and all processing of images in regions 402, 403, and 404 is complete before the system will process the images in region 405. On an even more granular level, during processing of computational blocks within a particular image capture region 405, a user or system may determine that one or more other computational blocks within the same image capture region or even a different image capture region corresponds to a higher priority area of interest on sample 114. But before the high resolution image segment of the higher priority interest area of the sample is available, the user or system must wait until processor 106 completes processing of all computational blocks of region 405 occurring in the computation sequence prior to the block of higher interest.

The presently disclosed embodiments aim to add flexibility in microscope 100 as an analysis tool and shorten analysis time by enabling prioritization of image capture and computational processing. For example a user may become interested in a particular second region of a sample (e.g., a region containing a blood cell) after viewing an initial low quality image, while the system is working on computation of a first region, and before computation process of the entire first region is complete. Instead of waiting for the entire computation process of the first region to complete, however, the user can request to prioritize a second computation process associated with the second region. In this example, first region may correspond to area of interest 401 and the second region may correspond to a different area of interest 406. Alternatively, first region may correspond to area of interest 401, and the second region may correspond to a particular image capture region within area of interest 401 (e.g., region 405 or any portion of region 405). Still further, first region may correspond to area of interest 401, and the second region may correspond to a region of the sample overlapped by one or more computational blocks 407 within capture region 405, for example. And prior to completion of image capture and/or processing according to a predetermined sequence for the first region, the system will respond by suspending image capture and/or processing associated with the first region in favor of image capture and/or processing of the second region. In this way, image information of higher interest areas of a sample becomes available in the order that the higher interest areas are identified and without having to wait until an initiated process has completed.

While the examples above are described with respect to the first region of sample 114 corresponding to area of interest 401, the first region of sample 114 may correspond to any other image areas. For example, the first region of sample 114 may correspond to image capture region 402, image capture region 403, image capture region 404, image capture region 405, or any other image capture region. Similarly, the first region of interest of sample 114 may correspond to any computational block in any area of interest, including any image capture region. The same may be equally true of the second region of interest of sample 114.

In one example, as each block may be associated with multiple images to be processed in order to generate an output image (e.g., a high resolution image generated based on lower resolution images or parts of images associated with each block), controller 106 may plan to begin processing images associated with capture region 402 of area of interest 401. The processing order can be to process the images associated with: capture region 402, capture region 403, capture region 404, and capture region 405, in accordance with the order in which the images were captured. However, controller 106 may receive a request (e.g., from a user or automated system) to prioritize processing of images associated with image capture region 405, which is the last region in the queue for processing. A request can be initiated by a person, or received by a program over a network or through user interface 112. After receiving the request, controller 106 may suspend the first computation process. Controller 106 may reorder the queue to prioritize processing of region 405, instead of following the original sequence: 402, 403, 404, and 405. After the prioritized region is processed, the queue may continue with the original order for processing. The new order can be, for example, 405, 402, 403, and 404.

In another embodiment, controller 106 may complete a computation process for the capture region (e.g., region 402) that it was working on when it received the new priority request. In such an embodiment, the new order of processing can be, for example, 402, 405, 403, and 404. In yet another embodiment, controller 106 may suspend processing of an image capture region (e.g., 402) before its completion. In such an embodiment, controller 106 may resume at the unfinished portion after completing computation process of the prioritized region (e.g., 405). For example, controller 106 may receive a prioritized capture region 405 to process when it has completed one-fifth (or other portion) of computation processing of a region 402. Once the prioritized region 405 is processed (which may result in an output image associated with the prioritized block being generated and optionally displayed), the system will return to the original partially processed region 402 to complete the remaining four-fifths of the processing. In such an embodiment, the new processing order can be, for example, 402 (partial), 405, 402 (remainder), 403, 404. In yet another embodiment, the prioritized region 405 can be processed simultaneously with the region 402 that was being processed before the prioritization request, e.g., through parallel-processing. In such an embodiment, the new processing order can be, for example, 402 and 405 (in parallel), 403, 404.

As another example, AOI 401 may correspond to a single FOV of image capture device 102. AOI 401 may be divided into computational blocks for computation (similar to image capture region 405 as shown in FIG. 4A). The predetermined sequence for processing computational blocks of AOI 401 may be 1, 2, 3, 4, where each number designates a computational block from among N computation blocks associated with AOI 401. While the intended order of processing may be 1,2,3,4, after completing the processing of block 1 and while processing block 2, a request arrives to prioritize a second region within AOI 401 that may correspond to one or more other blocks (e.g., block 4). The controller may be programmed or instructed to act in several ways, a few of which we will describe here: finish computing block 2 before moving on to block 4 in which case the order will be 1,2,4,3, etc. Suspend computing of block 2 and complete it after computing block 4, in which case the order will be 1,2,4,2,3, etc. Suspend computing of block 2, compute the prioritized block 4, further prioritize block 3 as adjacent to block 4 and complete block 2 after, in which case the order will be 1,2,4,3,2, etc. Suspend computing block 2, compute block 4, and stop computations until further instructions, in which case the order will be 1,2,4.

Another example may be where the AOI that was captured contains several FOVs of image capture device 102. Inside the AOI are a first region 404 and a second region 405. We will describe a few cases: the first region is being processed and the system was programmed or instructed not to include the second region in the queue (such a case can happen for example in analysis of a blood sample, where the system might detect a monolayer area and ignore areas on the “feathered edge” or “Bulk”). A user might request the second region to be prioritized and it will be added to the queue before, after or in parallel to the first region. Another case may be that the second region is later in the queue than the first region, and the system may prioritize it in a manner similar to those described above.

Several examples for prioritization have been described above. It should be noted that the described prioritization processes may be performed relative to any two or more regions associated with sample 114. Those regions of sample 114 may include computational blocks, image capture regions, areas of interest, fields-of-view associated with image capture device 102 or combinations thereof.

FIG. 4B is a schematic illustration 420 of an exemplary sample shown on user interface 112 with a second region separate from a first region, consistent with the disclosed embodiments. In this example, the second region of interest may be prioritized. As shown, second region 422 is a different section of sample 114 than first region 421. Image capture device 102 may be repositioned in order to gather images in second region 422. Motors (as shown in FIGS. 2 and 3) may move image capture device 102. In another embodiment, the motors may move stage 116 and/or sample 114 to position them so that capture device 102 can capture images of region 422. After capturing images of second region 422, controller 106 may initiate a computation process to generate the high resolution image of second region 422. After generating the high resolution image of second region 422, controller 106 may return to first region 421 to complete the image capture process and/or computation process. In another embodiment, the image capture processor and/or computation process may involve parallel processes. For example, one or more images of second region 422 may be captured while one or more images of first region 421 are being processed. In yet another embodiment, one or more images of second region 422 may be processed while one or more images of first region 421 are processed.

In one embodiment, user interface 112 displays sample 114. Sample 114 includes of various regions. For example, first region 421 includes of four blocks, and second region 422 includes two blocks. In one embodiment, controller 106 may begin a computation process for image 1 associated with block 1 of first region 421. The computation process order may be: block 1, block 2, block 3, and block 4 of first region 421, in accordance with the order in which the images were captured. Controller 106 may receive a request for prioritizing image capture for second region 422. In response, controller 106 may prioritize images captured of second region 422 in, for example, a computation queue. After the prioritized images are processed, controller 106 may continue to process the remaining images in the queue according to the original order for processing. For example, the original sequence of computation process was block 1, block 2, block 3, and block 4 of first region 421. The new order may be image capture process of block 1 of second region 422, image capture process of block 2 of second region 422, computation process of block 1 of first region 421, computation process of block 2 of first region 421, computation process of block 3 of first region 421, and computation process of block 4 of first region 421. In another embodiment, the prioritized image capture process of the second region may be performed simultaneously with the computation process of the first region, in parallel-processing.

FIG. 4C is a schematic illustration 440 of an exemplary image shown on a user interface 112 with a region surrounding a region of interest, consistent with the disclosed embodiments and as described in further detail in FIG. 5. A user is likely to be interested in an adjacent region close to region of interest 442. Accordingly, in some embodiments, controller 106 may be programmed to prioritize at least one adjacent region 443 to region of interest 442. In another case, the user's prioritizing region of interest 442 may indicate it is of relevance to him, and so controller 106 may look for further regions with mutual visual characteristics and further prioritize at least one region having a visual appearance similar to the second region. By way of example, the user or an algorithm may choose to examine a white blood cell in a sample, and the controller may detect more white blood cells from a low resolution image of the sample and further prioritize these areas for computing, and output them as high resolution images.

There are several potential methods in the field of computational imaging processing for producing a high-resolution image of a sample from a set of low-resolution images. One of these methods is, for example, ptychography. These methods are typically computationally intensive processes. The acquisition process may also be time consuming, and therefore there is value in prioritizing the computational process and/or the acquisition process in order to provide the most relevant parts of the image at an earlier time than would be possible when working in an order determined at first. Consistent with the present disclosure, controller 106 may receive images at a first image resolution and generate a reconstructed image of sample 114 having a second (enhanced) image resolution. The term “image resolution” is a measure of the degree to which the image represents the fine details of sample 114. The quality of a digital image may also be related to the number of pixels and the range of brightness values available for each pixel. In some embodiments, generating the reconstructed image of sample 114 is based on images having an image resolution lower than the enhanced image resolution. The enhanced image resolution may have at least 2 times, 5 times, 10 times, or 100 times more pixels than the lower image resolution images. For example, the first image resolution of the captured images may be referred to hereinafter as low-resolution and may have a value between 2 megapixels and 25 megapixels, between 10 megapixels and 20 megapixels, or about 15 megapixels. Whereas, the second image resolution of the reconstructed image may be referred to hereinafter as high-resolution and may have a value higher than 40 megapixels, higher than 100 megapixels, higher than 500 megapixels, or higher than 1000 megapixels.

FIG. 5 is an illustration of an exemplary process 500 for reconstructing an image of sample 114, consistent with disclosed embodiments. At step 502, controller 106 may acquire from image capture device 102 a plurality of low resolution images of sample 114. The plurality of images includes at least one image for each illumination condition. As mentioned above, the different illumination conditions may include at least one of: different illumination angles, different illumination patterns, different wavelengths, or a combination thereof. In some embodiments, the total number (N) of the plurality of different illumination conditions is between 2 to 10, between 5 to 50, between 10 to 100, between 50 to 1000, or more than 1000.

At step 504, controller 106 may determine image data of sample 114 associated with each illumination condition. For example, controller 106 may apply a Fourier transform on images acquired from image capture device 102 to obtain Fourier transformed images. The Fourier transform is an image processing tool which is used to decompose an image into its sine and cosine components. The input of the transformation may be an image in the normal image space (also known as real-space), while the output of the transformation may be a representation of the image in the frequency domain (also known as a Fourier-space). Consistent with the present disclosure, the output of a transformation, such as the Fourier transform, is also referred to as “image data.” Alternatively, controller 106 may use other transformations, such as a Laplace transform, a Z transform, a Gelfand transform, or a Wavelet transform. In order to rapidly and efficiently convert the captured images into images in the Fourier-space, controller 106 may use a Fast Fourier Transform (FFT) algorithm to compute the Discrete Fourier Transform (DFT) by factorizing the DFT matrix into a product of sparse (mostly zero) factors.

At step 506, controller 106 may aggregate the image data determined from images captured under a plurality of illumination conditions to form a combined complex image. One way for controller 106 to aggregate the image data is by locating in the Fourier-space overlapping regions in the image data. Another way for controller 106 to aggregate the image data is by determining the intensity and phase for the acquired low-resolution images per illumination condition. In this way, the image data, corresponding to the different illumination conditions, does not necessarily include overlapping regions.

At step 508, controller 106 may generate a reconstructed high-resolution image of sample 114. For example, controller 106 may apply the inverse Fourier transform to obtain the reconstructed image. In one embodiment, depicted in FIG. 5, the reconstructed high-resolution image of sample 114 may be shown on a display (e.g., user interface 112). In another embodiment, the reconstructed high-resolution image of sample 114 may be used to identify at least one element of sample 114. The at least one element of sample 114 may include any organic or nonorganic material identifiable using a microscope. Examples of the at least one element include, but are not limited to, biomolecules, whole cells, portions of cells such as various cell components (e.g., cytoplasm, mitochondria, nucleus, chromosomes, nucleoli, nuclear membrane, cell membrane, Golgi apparatus, lysosomes), cell-secreted components (e.g., proteins secreted to intercellular space, proteins secreted to body fluids, such as serum, cerebrospinal fluid, urine), microorganisms, and more. In some embodiments, the reconstructed image may be used in the following procedures: blood cell recognition, identification of chromosomes and karyotypes, detection of parasitic infections, and more.

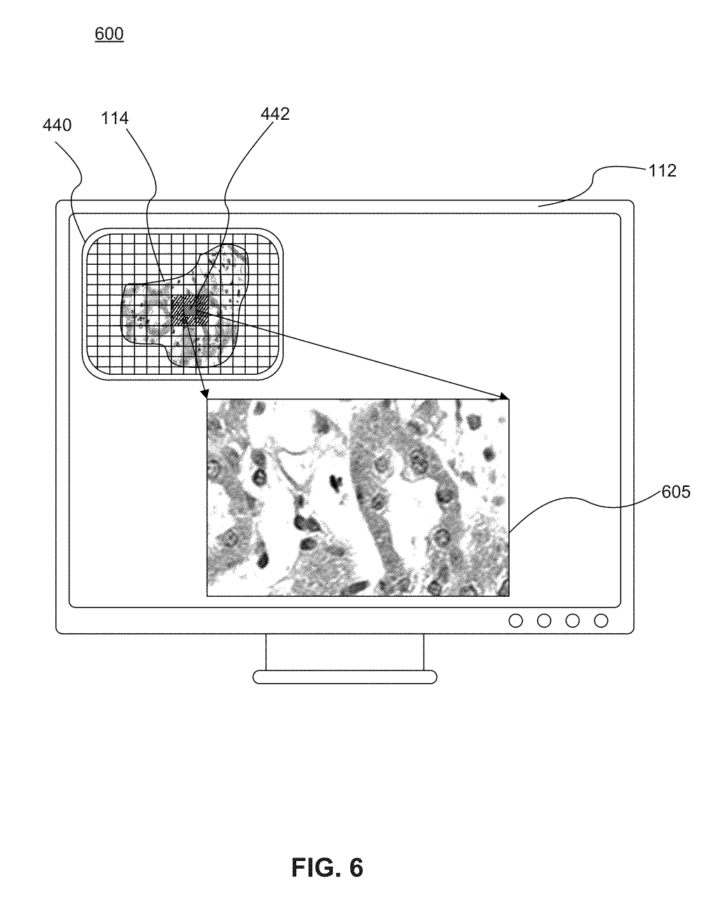

FIG. 6 is a schematic illustration 600 of an exemplary display showing a high resolution image generated from a region of interest, consistent with the disclosed embodiments. User interface 112 shows a view of a display 440. User interface 112 also shows a magnified view of a high resolution image 605 of region of interest 442 of sample 114.

By way of example, a user may observe the magnified view of high resolution image 605 and decide to initiate a request to view a high resolution image of region within region 442 that was already processed. In other embodiments, user interface 112 may display a low quality image of a first region of interest. A user may identify, based on the low quality image and before the completion of the computation process of the first region, a second region of interest within the first region. For example, using an external device connected or in communication with controller 106, the user may select regions to prioritize for processing.

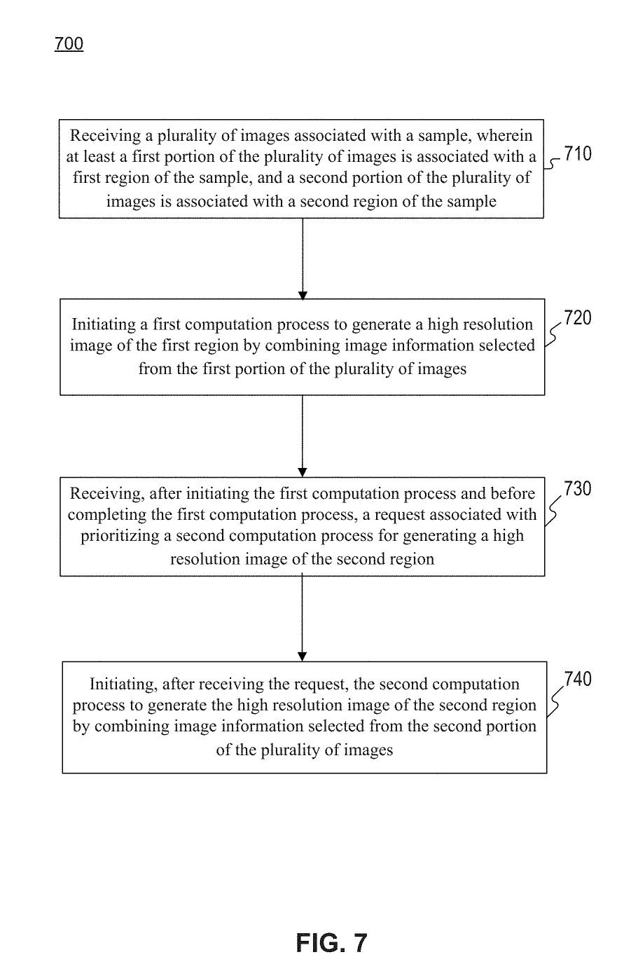

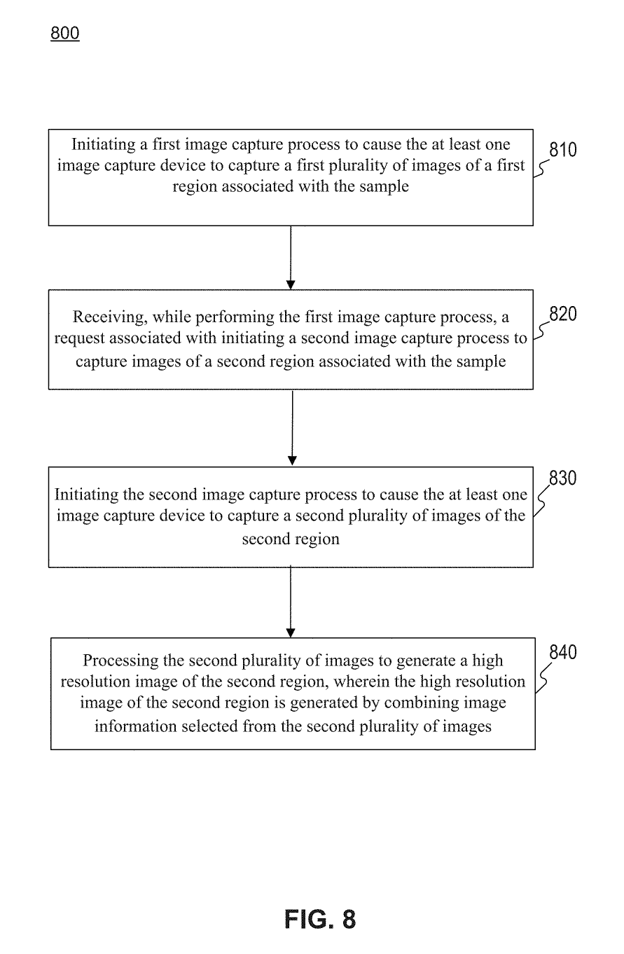

As discussed below in detail with regard to FIGS. 7 and 8, controller 106 may be programmed to execute program code including instructions associated with an algorithm. Such a controller may be considered to be a special-purpose controller including the program code (e.g., instructions) for executing the algorithms described below. For example, the program code may include one or more modules for controlling the actuators of the optics of a microscope to focus the microscope, for controlling the actuators of a sample moving element (e.g., to collect a scan of a desired region of a sample), and for receiving and recognizing input from a user. For example, the one or more modules may recognize keyboard punches, touch screen touches, pointer device input, etc., in order to set interrupts and respond to the user inputs potentially mid-process and/or by suspending an ongoing scanning or computing process.

FIG. 7 is a flowchart 700 showing an exemplary process for prioritizing a computation process of images associated with a particular region of interest, consistent with the disclosed embodiments.

At step 710, controller 106 may receive a plurality of images associated with a sample. The plurality of images may have been captured by, for example, image capture device 102. At least a first portion of the plurality of images may be associated with a first region of the sample, and a second portion of the plurality images may associated with a second region of the sample. In some embodiments, the first region and the second region may partially overlap. In other embodiments, the first region and the second region may not overlap. In some embodiments, the first region and the second region may relate to the same or different fields-of-view, and/or the first region and the second region may be included in portions of the same images. By way of example, regions one and two may include tiles taken from the same portion of the plurality of images. In another example, they may be tiles from two different pluralities of images, such as the images taken from two separate areas of the sample that were imaged at different relative positions between sample 114 and capture device 102.

Further, in some embodiments, controller 106 may store the plurality of images in memory 108. In some embodiments, controller 106 may store identifiers corresponding to each image from the plurality of images in a computation queue for processing. Identifier in this document may refer to any property of the image or its meta-data that can help inform the system of the required actions or information needed. Examples may be: alphanumeric indexing or filenames, part of an image, location coordinates, calculated values from the image such as: brightness, contrast, sharpness, recognition of objects in the image, existence or prevalence of visual features and others. Moreover, in some embodiments, controller 106 may prioritize processing of at least two of the plurality of images or regions stored in memory 108 according to a sequence specified by a computation queue or an algorithm. For example, controller 106 may prioritize processing of the first portion of the plurality of images stored in memory 108 and the second portion of the plurality of images stored in memory 108 according to a sequence specified by a computation queue or an algorithm.

At step 720, controller 106 may initiate a first computation process to generate a high resolution image of the first region by combining image information selected from the first portion of the plurality of images. For example, controller 106 may apply a transformation on at least two of the plurality of images to obtain Fourier transformed images. Further, controller 106 may initiate the process to aggregate the image data of first region determined from images captured under a plurality of illumination conditions to form a combined image. The combined image may constitute a high resolution image having a resolution higher than any of the individual images.

At step 730, controller 106 may receive, after initiating the first computation process and before completing the first computation process, a request associated with prioritizing a second computation process for generating a high resolution image of the second region. Controller 106 may receive the request from an external device or a program (e.g., an algorithm) over a network or locally using an input device or a program (e.g., an algorithm). In some embodiments, the request may include one or more identifiers (e.g., alphanumeric identifiers) associated with the second region. After receiving the request, controller 106 may change an order of the sequence specified by the computation queue or algorithm discussed above in step 710. Further, in some embodiments, controller 106 may prioritize at least one region of interest adjacent to the second region or at least one region of interest having a visual appearance similar to the second region.

In some embodiments, after receiving the request discussed above in step 730, controller 106 may suspend the first computation process. However, in other embodiments, after receiving the request, controller 106 may complete the first computation process before initiating a second computation process, which is discussed below in connection with step 740. In still yet other embodiments, after receiving the request, controller 106 may perform the first computation process and a second computation process (discussed below in connection with step 740) in parallel.

At step 740, controller 106 may initiate, after receiving the request, a second computation process to generate a high resolution image of the second region by combining image information selected from the second portion of the plurality of images. Controller 106 may apply a transformation on images of the second region to obtain Fourier transformed images. Further, controller 106 may initiate a process to aggregate image data of second region determined from images captured under a plurality of illumination conditions to form a combined image. The combined image may constitute a high resolution image of the second region that has a resolution higher than any individual image used to generate the high resolution image. In some embodiments, controller 106 may output the high resolution image of the second region to a display or to an external device.

Additional modifications and/or additions to the above process are consistent with the disclosed embodiments. For example, in some embodiments, controller 106 may resume the first computation process after completing the second computation process. That is, in embodiments in which controller 106 suspended the first computation process after reviving the request, controller 106 may, after the second computation processed discussed above in connection with step 740 has completed, resume the first computation process. Resuming the first computation process may result in a high resolution image of the first region that has a resolution higher than any individual image used to generate the high resolution image.

FIG. 8 is a flowchart 800 showing an exemplary process for prioritizing the image capture process of images associated with a particular region of interest, consistent with the disclosed embodiments.

At step 810, controller 106 may initiate a first image capture process to cause image capture device 102 to capture a first plurality of images of a first region associated with a sample.

At step 820, controller 106 may receive while performing the first image capture process, a request associated with initiating a second image capture process to capture images of a second region associated with the sample. Controller 106 may receive the request from an external device or a program (e.g., an algorithm) over a network. The request may include one or more identifiers (e.g., alphanumeric identifiers) associated with the second region. For example, controller 106 may use the identifiers to identify regions of the sample to acquire and/or regions of the sample in images for computation. In one example, the request may include only identifiers of the second region, and is not preceded by a request to stop the capture process of the first region. This may be desirable, as it requires less user operations and may also enable the system to resume the process of the first region at a later time without ambiguity in regards to the user intentions.

In some embodiments, after receiving the request, image capture device 102 may suspend the first image capture process. A second image capture process, discussed below in connected with step 830, may then be initiated after suspending the first image capture process.

At step 830, controller 106 may initiate the second image capture process to cause the at least one image capture device to capture a second plurality of images of the second region. In embodiments in which controller 106 suspended the first image capture process, after suspending the first image capture process, controller 106 may cause a motor to steer image capture device 102 to a new position based on a location of the second region. For example, controller 106 may initiate motors (e.g., as shown in FIGS. 2 and 3) to move image capture device 102 to the second region. In another example, controller 106 may initiate motors (in a different embodiment than is shown in FIGS. 2 and 3) to move stage 116 with sample 114 so the second region is placed under image capture device 102.

At step 840, controller 106 may process the second plurality of images to generate a high resolution image of the second region. The high resolution image of the second region may be generated by combining image information selected from the second plurality of images. For example, controller 106 may place each image or partial region such as a tile, from the second plurality of images in a queue for computation processing. Controller 106 may apply a transformation on images acquired from image capture device 102 to obtain Fourier transformed images in the order of elements in the queue. Controller 106 may initiate process to aggregate the image data of second region determined from images captured under a plurality of illumination conditions to form a combined image. The combined image may constitute a high resolution image of the second region that has a resolution higher than any individual one of the second plurality of images. In some embodiments, controller 106 may output the high resolution image of the second region to a display or to an external device.

Additional modifications and/or additions to the above process are consistent with the disclosed embodiments. In some embodiments controller 106 may resume the first image capture process after the high resolution image of the second region is generated. However, in other embodiments, before the high resolution image of the second region is generated, controller 106 may resume the first image capture process. In yet other embodiments, controller 106 may resume the first image capture process while the high resolution image of the second region is being generated.

After resuming the first image capture process, controller 106 may generate the high resolution image of the second region. In yet other embodiments, controller 106 may generate the high resolution image of the second region before resuming the first image capture process.

In some embodiments, the first region and the second region discussed in connection with FIG. 7 may partially overlap. In this document, to partially overlap may refer to a situation whereby at least a part of both regions represent the same area on sample 114. For example, one region may be contained in another. In another example, both regions have mutual areas but each region also contains an area not covered by the other region. In other embodiments, the first region and the second region may not overlap.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices; for example, hard disks, floppy disks, CD ROM, other forms of RAM or ROM, USB media, DVD, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, python, Matlab, Cuda, HTML, HTML/AJAX combinations, XML, or HTML with included Java applets. One or more of such software sections or modules can be integrated into a computer system or existing e-mail or browser software.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed routines may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A microscope for processing images of a sample, the microscope comprising:
an illumination assembly configured to illuminate the sample under two or more different illumination conditions;
at least one image capture device configured to capture image information associated with the sample;
at least one controller programmed to:
receive, from the at least one image capture device, a plurality of images associated with the sample, wherein at least a first portion of the plurality of images is associated with a first region of the sample, and a second portion of the plurality of images is associated with a second region of the sample;
initiate a first computation process to generate a high resolution image of the first region by combining image information selected from the first portion of the plurality of images;
receive, after initiating the first computation process and before completing the first computation process, a request associated with prioritizing a second computation process for generating a high resolution image of the second region; and
initiate, after receiving the request, the second computation process to generate the high resolution image of the second region by combining image information selected from the second portion of the plurality of images.

2. The microscope of claim 1, wherein, after receiving the request, the at least one controller is further programmed to suspend the first computation process.

3. The microscope of claim 2, wherein the at least one controller is further programmed to resume the first computation process after completing the second computation process.

4. The microscope of claim 1, wherein, after receiving the request, the at least one controller is further programmed to complete the first computation process before initiating the second computation process.

5. The microscope of claim 1, wherein, after receiving the request, the at least one controller is further programmed to perform the first computation process and the second computation process in parallel.

6. The microscope of claim 1, wherein the first region and the second region partially overlap.

7. The microscope of claim 1, wherein the first region and the second region do not overlap.

8. The microscope of claim 1, wherein the plurality of images are stored in a memory.

9. The microscope of claim 8, wherein the at least one controller is further programmed to prioritize processing of the first portion of the plurality of images stored in the memory and the second portion of the plurality of images stored in the memory according to a sequence specified by a computation queue or an algorithm.

10. The microscope of claim 9, wherein, after receiving the request, the at least one controller is further programmed to change an order of the sequence.

11. The microscope of claim 1, wherein the controller is further programmed to prioritize at least one region of interest adjacent to the second region or at least one region of interest having a visual appearance similar to the second region.

12. The microscope of claim 1, wherein the high resolution image of the first region has a resolution higher than any individual one of the plurality of images, and the high resolution image of the second region has a resolution higher than any individual one of the plurality of images.

13. The microscope of claim 1, wherein the request is received over a network from a computing device.

14. The microscope of claim 1, wherein the request includes one or more identifiers associated with the second region.

15. The microscope of claim 1, wherein the at least one controller is further programmed to output the high resolution image of the second region to a display.

16. The microscope of claim 1, wherein the at least one controller is further programmed to output the high resolution image of the second region to an external device.

17. A method for processing images of a sample, the method comprising:
receive, from at least one image capture device, a plurality of images associated with the sample, wherein at least a first portion of the plurality of images is associated with a first region of the sample, and a second portion of the plurality of images is associated with a second region of the sample;
initiate a first computation process to generate a high resolution image of the first region by combining image information selected from the first portion of the plurality of images;
receive, after initiating the first computation process and before completing the first computation process, a request associated with prioritizing a second computation process for generating a high resolution image of the second region; and
initiate, after receiving the request, the second computation process to generate the high resolution image of the second region by combining image information selected from the second portion of the plurality of images.

18. A microscope for processing images of a sample, the microscope comprising:
an illumination assembly configured to illuminate the sample under two or more different illumination conditions;
at least one image capture device configured to capture image information associated with the sample;
at least one controller programmed to:
initiate a first image capture process to cause the at least one image capture device to capture a first plurality of images of a first region associated with the sample;
receive, while performing the first image capture process, a request associated with initiating a second image capture process to capture images of a second region associated with the sample;
initiate the second image capture process to cause the at least one image capture device to capture a second plurality of images of the second region; and
process the second plurality of images to generate a high resolution image of the second region, wherein the high resolution image of the second region is generated by combining image information selected from the second plurality of images.

19. The microscope of claim 18, wherein the request includes a plurality of identifiers associated with the second region.

20. The microscope of claim 18, wherein the at least one controller is further programmed to cause, after receiving the request, the at least one image capture device to suspend the first image capture process, and wherein the second image capture process is initiated after suspending the first image capture process.

21. The microscope of claim 20, wherein the at least one controller is further programmed to resume the first image capture process after the high resolution image of the second region is generated.

22. The microscope of claim 20, wherein the at least one controller is further programmed to resume the first image capture process before the high resolution image of the second region is generated.

23. The microscope of claim 20, wherein the at least one controller is further programmed to resume the first image capture process while the high resolution image of the second region is generated.

24. The microscope of claim 20, wherein the at least one controller is further programmed to generate the high resolution image of the second region before resuming the first image capture process.

25. The microscope of claim 20, wherein the at least one controller is further programmed to generate the high resolution image of the second region after resuming and completing the first image capture process.

26. The microscope of claim 18, wherein the high resolution image of the second region has a resolution higher than any individual one of the second plurality of images.

27. The microscope of claim 18, wherein the first region and the second region partially overlap.

28. The microscope of claim 18, wherein the first region and the second region do not overlap.

29. The microscope of claim 18, further comprising at least one motor configured to cause relative movement between the sample and the at least one image capture device.

30. The microscope of claim 18, wherein the request is received over a network from an external device.

31. The microscope of claim 18, wherein the request includes one or more identifiers associated with the second region.

32. The microscope of claim 18, wherein the at least one controller is further programmed to output the high resolution image of the second region to a display.

33. The microscope of claim 18, wherein the at least one controller is further programmed to output the high resolution image of the second region to a computing device.

34. A method for processing images of a sample, the method comprising:
initiate a first image capture process to cause at least one image capture device to capture a first plurality of images of a first region associated with the sample;
receive, while performing the first image capture process, a request associated with initiating a second image capture process to capture images of a second region associated with the sample;
initiate the second image capture process to cause the at least one image capture device to capture a second plurality of images of the second region; and
process the second plurality of images to generate a high resolution image of the second region, wherein the high resolution image of the second region is generated by combining image information selected from the second plurality of images.
